(19) United States
(12) Patent Application Publication
(10) Pub. No.: US 2010/0266840 A1
(43) Pub. Date: Oct. 21, 2010

(54) ARTICLES WITH LOW HYDROGEN PERMEATION AND THEIR USE

(75) Inventors: Dragan Griebel, Rehau (DE); Stefan Brand, Hirschberg-Leutershausen (DE); Udo Steffl, Weidenberg (DE)

Correspondence Address: SEED INTELLECTUAL PROPERTY LAW GROUP PLLC, 701 FIFTH AVE, SUITE 5400, SEATTLE, WA, 98104, US

(73) Assignees: CLARIANT INTERNATIONAL LTD., Muttenz (CH); REHAU AG + CO., Rehau (DE)

(21) Appl. No.: 12/670,176

(22) PCT Filed: Jul. 23, 2008
(86) PCT No.: PCT/EP08/06050

§ 371 Date: Jun. 25, 2010

(30) Foreign Application Priority Data
Jul. 24, 2007 (DE) 10 2007 034 393.2

(51) Int. Cl. B32B 27/08; B32B 5/00

(52) U.S. Cl. 428/334; 428/446

(57) ABSTRACT

The invention relates to use of a molding molded from a composition encompassing (A) a thermoplastic, and a coating provided thereon, molded from a composition encompassing a component (B) which has been selected from a polysilazane of the formula (—SiR′R″—NR′″-)n, where either R′, R″ and R′″=—H, or R′ and R′″=—H; and R′″=-methyl, as articles with low hydrogen permeation, where the permeation coefficient of the article with respect to hydrogen gas at from 25 to 30° C. is preferably smaller than 10 cm³ mm/m² d atm, measured in accordance with DIN 53380-3 and ASTM D 3985, and their microhardness is greater than 150 N/mm² to DIN EN ISO 14577. The invention further relates to articles with low hydrogen permeation encompassing a molding molded from a composition encompassing (A) a thermoplastic, and a coating provided thereon, molded from a composition encompassing a component (B) which has been selected from a polysilazane of the formula (—SiR′R″—NR′″-)n, where either R′, R″ and R′″=—H, or R′ and R′″=—H; and R′″=-methyl.

The present invention relates to an article with low hydrogen permeation, for example for pipes, hoses, moldings or containers.

Barrier materials are used in all fields of industry and economy, in particular the field of food and beverage packages; normally, they bring about an increased durability of food. Apart from the barrier effect with respect to oxygen and water vapor, the retaining power for nitrogen, odorous matter and flavors is also becoming increasingly important. Apart from permeation, barrier materials in some cases also reduce migration of, for example, low-molecular organic compounds and thus protect the packed goods from taints.

Permeation takes place in the steps of adsorption and sorption at the surface of the material, diffusion through the material itself and subsequent desorption.

A semi-crystalline, nonpolar polyolefin has a good barrier effect with respect to water vapor; water vapor permeability according to DIN 53122 is typically 1 g/m² d, but at the same time it has a bad oxygen barrier effect, oxygen permeability according to DIN 53380 is typically 5000 to 8000 cm³/m² d bar.

Barrier plastics, such as EVOH or PVDC or LCP, have a high barrier effect with respect to water as well as with respect to oxygen. However, all these materials fail when it comes to high barrier applications or even to the barrier effect with respect to hydrogen gas.

In packaging foils, one is passing on to vapor-depositing polymeric barrier layers with aluminum to further reduce permeation rates. In the process, aluminum layers within a range of only a few nanometers to micrometers are vapor-deposited in high vacuum. In most cases, this brings about the desired barrier effect.

However, the high costs of such a coating as well as the fact that the plastics treated by vapor deposition are no longer transparent are disadvantageous.

Another way is described in the magazine Surface and Coatings Technology 111 (1999) p. 72 to 79. SiOx layers are deposited by means of PVD processes and additionally sealed with so-called Ormocer coatings—also inorganic-organic hybrid coatings. Due to the multi-stage application method, this way is economically totally unattractive and did therefore not find its way into practice.

From DE 102004001288 A1, a hydrophilic surface coating for materials, such as metal, glass, ceramics, plastics, lacquers or porous surfaces, is known.

The coating contains one or several polysilazanes and an ionic reagent or mixtures of ionic reagents.

For storing and transporting hydrogen, usually parts of stainless steel are employed today due to a lack of alternatives of material. Therefore, hydrogen-carrying pipes are inflexible and difficult to lay, and the corresponding stainless steel containers have a high weight and are restricted as to their design.

JP-A-10016150 discloses a gas barrier film with transparency and good flexibility as well as thermal resistance which is provided in the form of a ceramic layer, formed by applying a polysilazane coating composition onto at least one surface of a polyvinyl alcohol film, followed by conversion of the polysilazane coating into a ceramic layer. This laminate can be used as gas barrier film. JP-A-11151774 discloses a transparent gas barrier film. For this, a film of an inorganic oxide deposited from the gaseous phase, provided on the surface of a base material, is coated with a coating film by applying a solution with a polysilazane, followed by heating and drying. JP-A-2000246830 describes a silica-coated plastic film, where the silica-coated plastic film is to comprise good resistance to alkaline substances as well as excellent adhesive properties and gas barrier properties, where the film consists of a PET base film coated with a polysilazane solution.

All these documents do not disclose any further information in view of the gas barrier properties, in particular they do not disclose with respect to which gases the respective films are to comprise barrier properties.

WO 2004/039904 and WO 2006/056285 describe polysilazane-based coating solutions as well as their use, in particular for coating polymeric films. The coatings generated thereby are described as protective layers for providing corrosion resistance, antiscratch properties, abrasion resistance, antifouling properties, sealing properties, chemical resistance, oxidation resistance, thermal resistance, antistatic properties as well as a barrier effect. In view of barrier effects, these international patent applications only disclose information in view of oxygen permeability.

However, oxygen considerably differs with respect to its permeation properties from other gases, such as oxygen or carbon dioxide, so that information in view of a possibly existing barrier property with respect to oxygen does not have any meaning with respect to the suitability to increase the barrier effect with respect to hydrogen.

Here, the invention comes into play which made it its object to provide articles for the storage and transport of hydrogen which do not comprise the mentioned disadvantages and problems, that means which are of low weight, easily deformable and resistant to scratching and in particular have a low permeation coefficient with respect to hydrogen gas at 25 to 30° C. of smaller than 10, preferably smaller than 7.50, and in particular smaller than 3 cm³ mm/m² d atm, measured in accordance with DIN 53380-3/ASTM D 3985.

According to the invention, the achievement of the object succeeds by the use of an article having the features of claim 1 as well as by the provision of an article having the features of claim 8.

Preferred embodiments and further developments of the invention are illustrated in the subclaims and independent claims.

The article according to the invention is composed of a

(I) component (A) which consists of a thermoplastically processable plastics, and

(II) a component (B), consisting of a polysilazane which is applied onto component (A)

by a coating process.

Component (B) can furthermore contain residues of a catalyst, such as e.g. ammonium salts, ethylene diamine, amines, pyridine derivatives, radical initiators, or metallo-organic compounds (e.g. 0.05 to 5 weight percent of a palladium compound), so that the reaction can be carried out at low temperatures.

The article according to the invention preferably comprises a permeation coefficient with respect to hydrogen gas at 25 to 30° C. of smaller than 10, preferably smaller than 7.50, more preferably smaller than 5, and in particular smaller than 3 cm³ mm/m² d atm, measured in accordance with DIN 53380-3 and ASTM D 3985, and is furthermore characterized by a microhardness (as measure for scratch resistance) of greater than 150 N/mm², more preferably greater than 155, and in embodiments greater than 300 according to DIN EN ISO 14577 of the coated component (A).

Below, the invention will be illustrated more in detail.

Component (A) of the article according to the invention is a thermoplastic, selected from the group of the polyolefins or polyolefin derivatives or polyolefin copolymers, such as e.g. polyethylene or polypropylene, or from the group of the vinyl polymers, such as polystyrene or polystyrene copolymers, or from the group of the polyamides, such as polyamide 6 or polyamide 66, or from the group of the polyesters, such as polyethylene terephthalate or polybutylene terephthalate, or from the group of the aromatic polysulphides or aromatic sulphones.

In the thermoplastic, additions in the form of lubricants or processing aids, fillers, such as talc, nucleation agents, stabilizers, antistatic agents, impact resistance modifiers, flame retardants, fibers, conductivity additives, can be possibly contained according to the invention.

Furthermore, the article according to the invention can comprise, apart from the layer of component (A), still other layers, depending on the field of application of the article with low hydrogen permeation. For example, in pipes or hoses as well as in other storage containers (for example tank), an additional protective layer, a colored layer (for facilitating identification), etc. can be provided. Such embodiments are well-known to the person skilled in the art in the respective field.

According to the invention, it showed that layers generated by applying a polysilazane containing composition surprisingly provide improved barrier properties with respect to hydrogen permeation. In this context, it is essential that the polysilazane has the formula defined in claim 1.

According to the invention, component (B) is a perhydro-polysilazane of the formula (—SiR′R″—NR′″-)n with R′=R′″=R′″=—H (see embodiments 1 to 3), or a polysilazane with the composition R′=R′″=—H, and R′″=-methyl (see embodiments 4 to 6), wherein n is an integer and n is preferably designed such that the polysilazane comprises a number-average molecular weight of 150 to 150000 g/mol, as disclosed in WO 2006/056285 A1.

It is in particular preferred that component (B) is a perhydro-polysilazane with R′=R′″=R′″=—H. This brings about particularly good barrier properties with respect to hydrogen permeation.

The polysilazane, to be used in accordance with the present invention, is processed in the form of a solution by usual means. As concerns suited solvents, concentrations of polysilazane and possible additives, catalysts etc., reference is made to the disclosure of the two international patent applications WO 2004/039904 and WO 2006/056285 which are included herein by this reference.

The application of component (B) is accomplished by submerging, flooding, spin coating or spraying.

Hardening can be carried out according to the invention at room temperature or preferably at an elevated temperature, in particular at approximately 80° C.

After application has been completed, the layer thickness of the coating is within a range of 0.01 to 100 μm, preferably 0.5 to 5 μm.

This layer is preferably applied directly onto the molding, formed with the thermoplastic plastics, without intermediate additional layer, such as, for example, the oxide layers often used in prior art, or else adhesive layers or support layers.

Preferably, a previous activation or pretreatment of the substrates, in particular by means of a plasma treatment, is carried out, if required.

The coated articles according to the invention are preferably employed in the electronic, electric, automotive or construction field as hydrogen transport pipes and hoses, hydrogen tanks, moldings for these applications and the like.

Table 1 below shows the properties of the articles coated according to the invention.

TABLE 1

| Property | Unit | Standard | 1 | 2 | 3 | 4 | 5 | 6 |
|---|---|---|---|---|---|---|---|---|
| Hydrogen | [cm³ mm/m² | in accordance | 1.91 | 2.20 | 2.53 | 3.25 | 5.62 | 7.10 |
| permeation | d atm] | with DIN 53380- | | | | | | |
| coefficient at | | 3/ASTM D 3985 | | | | | | |
| 25-30° C. | | | | | | | | |
| Thickness of | [μm] | — | 2 | 2 | 2 | 1 | 1 | 1 |
| coating after | | | | | | | | |
| hardening | | | | | | | | |
| Total thickness | [mm] | — | 0.054 | 0.056 | 0.063 | 0.055 | 0.065 | 0.048 |
| Microhardness | [N/mm²] | DIN EN ISO | 351 | 332 | 347 | 159 | 158 | 156 |
| | | 14577 | | | | | | |

### TO THE EXAMPLES 1 TO 3

A 50 μm thick polyethylene foil is pretreated by means of plasma and coated with a perhydro-polysilazane solution in a mixture of dibutyl ether and anisole by spraying, flashed off for 10 min. at room temperature and subsequently hardened for 2 h at 80° C., so that a 2 μm thick barrier layer results.

The hydrogen permeation coefficient is determined at the foil in accordance with DIN 53380-3/ASTM D 3985, as described below.

### TO THE EXAMPLES 4 TO 6

A 50 μm thick polyethylene foil is coated with a solution of a polysilazane of the formula (—SiR′R″—NR′″-)n, with R′=R′″=—H and R′″=-methyl in di-n-butyl ether by dip coating and flashed off for 2 min at room temperature, and subsequently hardened for 30 min at 70° C., so that a 1 μm thick barrier layer results.

The hydrogen permeation coefficient is determined in accordance with DIN 53380-3/ASTM D 3985 as follows:

50 μm thick foils of component (A) coated with component (B) were glued between two aluminum foils with round cutouts for masking.

After the installation of these test samples, the measuring cell was purged on the feed side with forming gas or hydrogen, respectively, on the permeate side with air.

The H₂ content of this purge air was determined by means of an H₂ sensor (Sensistor Hydrogen Leak Detector H 2000).

Evaluation was accomplished by averaging several measured values after the balance had been adjusted taking into consideration the purge gas flow.

Table 2 below shows the properties of the Comparative Examples of known packing materials.

### COMPARATIVE EXAMPLE 1

Comparative Example 1 is a 0.126 mm thick aluminum foil.

### COMPARATIVE EXAMPLE 2

Comparative Example 2 is a 0.182 mm thick polyethylene foil.

### COMPARATIVE EXAMPLE 3

Comparative Example 3 is a 0.230 mm thick foil of a liquid-crystalline polymer LCP.

### COMPARATIVE EXAMPLE 4

Comparative Example 4 is a 0.262 mm thick polytetrafluoroethylene foil.

TABLE 2

| | | | Comparative | Comparitive | Comparative | Comparative |
|---|---|---|---|---|---|---|
| Property | Unit | Standard | Example 1 | Example 2 | Example 3 | Example 4 |
| Hydrogen | [cm³ mm/m² | in accordance | 0.21 | 287 | 19 | 293 |
| permeation | d atm] | with DIN 53380-3 | | | | |
| coefficient at | | | | | | |
| 25-30° C. | | | | | | |
| Thickness | [mm] | — | 0.126 | 0.182 | 0.230 | 0.262 |
| Microhardness | [N/mm²] | DIN EN ISO | 557.92 | 0.40 | 141.56 | 75.02 |
| | | 14577 | | | | |

The articles of the polysilazane-coated thermoplastics used according to the invention comprise a hydrogen permeation coefficient which is nearly at the level of a 0.126 mm thick aluminum foil and is essentially reduced with respect to the pure polyethylene foil.

Moreover, permeation examinations in response to temperature have been carried out (at 23° C., 40° C. and 60° C.):

a) Measurement with H₂ dry;

b) Measurement with H₂ humid=H₂ and purge gas with 100% relative humidity.

The results indicate that neither the temperature nor the humidity has any negative influence on the barrier effect of the coating.

It even shows that the relative improvement of the barrier increases as temperature increases.

Furthermore, a conditioning of the samples (which is mounted, one side being exposed to a vacuum for 2 days at 23° C.) with a mixture of isooctane/toluene and water results in an improved H₂ barrier.

1. Use of a molding, formed from a composition comprising (A) a thermoplastic plastics as well as a coating provided thereon, formed from a composition comprising a component (B) which is selected from a polysilazane of the formula (—SiR′R″—NR″-)n, where either R′, R″ and R′″=—H or R′ and R′″=—H; and R′″=-methyl, as article with low hydrogen permeation.

2. Use according to claim 1, wherein the article comprises a permeation coefficient with respect to hydrogen gas at 25 to 30° C. of smaller than 10 cm³ mm/m² d atm, measured in accordance with DIN 53380-3 and ASTM D 3985, and a microhardness of greater than 150 N/mm² according to DIN EN ISO 14577.

3. Use according to claim 1, characterized in that the thermoplastic plastics of component (A) is selected from the group of the polyolefins or polyolefin derivatives or polyolefin copolymers, such as e.g. polyethylene or polypropylene, or from the group of the vinyl polymers, such as polystyrene or polystyrene copolymers, or from the group of the polyamides, such as polyamide 6 or polyamide 66, or from the group of the polyesters, such as polyethylene terephthalate or polybutylene terephthalate, or from the group of the aromatic polysulphides or aromatic sulphones.

4. Use according to claim 1, characterized in that the application of component (B) is accomplished by submerging, flooding, spin coating or spraying, and hardening is accomplished at room temperature, preferably at an elevated temperature, in particular at approximately 80° C.

5. Use according to at least one of claims 1 to 4, characterized in that the thickness of the coating, after the application has been completed, is within a range of 0.01 to 100 μm, preferably 0.5 to 5 μm.

6. Use according to one of the preceding claims preferably in the electronic, electric, automotive or construction field, preferably as hydrogen transport pipe and hose or hydrogen tank or a molding used for this.

7. Use of a component (B) which is selected from a polysilazane of the formula (—SiR′R″—NR′″-)n, where either R′, R″ and R′″=—H, or R′ and R′″=—H; and R′″=-methyl, for producing a coating for reducing hydrogen permeation through a molding, manufactured from a thermoplastic plastics.

8. Article with low hydrogen permeation, comprising a molding, formed from a composition comprising (A) a thermoplastic plastics, as well as a coating provided thereon, formed from a composition comprising a component (B) which is selected from a polysilazane of the formula (—SiR′R″—NR′″-)n, where either R′, R″ and R′″=—H, or R′ and R′″=—H; and R′″=-methyl.

9. Article according to claim 8, characterized in that the thermoplastic plastics of component (A) is selected from the group of the polyolefins or polyolefin derivatives or polyolefin copolymers, such as e.g. polyethylene or polypropylene, or from the group of the vinyl polymers, such as polystyrene or polystyrene copolymers, or from the group of the polyamides, such as polyamide 6 or polyamide 66, or from the group of the polyesters, such as polyethylene terephthalate or polybutylene terephthalate, or from the group of the aromatic polysulphides or aromatic sulphones.

10. Article according to at least one of claim 8 or 9, characterized in that the thickness of the coating, after the application has been completed, is within a range of 0.01 to 100 μm, preferably 0.5 to 5 μm.
